(19) United States
(12) Patent Application Publication
(10) Pub. No.: US 2005/0114669 A1
(43) Pub. Date: May 26, 2005

(54) Image protection system and method

(76) Inventors: Cheng-Hung Ho, Taipei City (TW); Wen-Hao Hsu, Kaoshiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/811,115

(22) Filed: Mar. 26, 2004

(30) Foreign Application Priority Data
Nov. 26, 2003 (TW) 92133140

(51) Int. Cl. H04L 9/00

(52) U.S. Cl. 713/176

(57) ABSTRACT

An image protection system and method. The system includes at least an image compression/encryption device having a compression unit, an encryption unit and an image composing unit. The compression unit separates an image into base image data and auxiliary image data according to a compression technique, and compresses the base image data to compressed base image data according to the compression technique. The encryption unit encrypts the auxiliary image data to an auxiliary image data cipher. The image composing unit composes the compressed base image data and the auxiliary image data cipher into a protected image corresponding to the image.

### BACKGROUND OF THE INVENTION

1. Field of the Invention

The present invention relates to an image protection system and method, and particularly to an image protection system and method that integrates compression and encryption techniques simultaneously, such that users with no authorization can view a partial image, while users with authorization can view a complete image.

2. Description of the Related Art

With the development of information technology, digital content has become a subject of interest to users and developers alike. Additionally, the popularization of computers and networks has made digital content collection, utilization, and transmission convenient and beneficial.

FIG. 1 illustrates a conventional mechanism for digital content protection. As shown in FIG. 1, the digital content 100 is first encrypted to generate a digital content cipher 120 by an encryption unit 110. The digital content cipher 120 can be transmitted via a network 130. To use the digital content 100, authorization must be granted and a corresponding decryption key 150 is generated for decryption the digital content cipher 120 into the digital content 100 by a decryption unit 140 accordingly. Conventionally, users cannot view the complete digital content if they do not possess the authorization and decryption key.

This method, from a sales perspective is detrimental, as users are unlikely to make impulsive image purchases if they are only able to view a description and not the actual digital content. Thus conventional method is not suitable for use in digital content promotion and sales.

### SUMMARY OF THE INVENTION

It is therefore an object of the present invention to provide an image protection system and method that integrates compression and encryption techniques simultaneously.

To achieve the above object, the present invention provides an image protection system. The system includes an image compression/encryption device having a compression unit, an encryption unit and an image composing unit. The compression unit separates an image into base image data and auxiliary image data according to a compression technique, and compresses the base image data to compressed base image data according to the compression technique. The encryption unit encrypts the auxiliary image data to an auxiliary image data cipher. The image composing unit composes the compressed base image data and the auxiliary image data cipher into a protected image corresponding to the image.

The system further includes an image recovery device having an image decomposition unit, a decryption unit and a decompression unit. The image decomposition unit decomposes the protected image into the compressed base image data and the auxiliary image data cipher. The decryption unit decrypts the auxiliary image data cipher to the auxiliary image data using a decryption key. The decompression unit decompresses the compressed base image data to the base image data, and combines the base image data and the auxiliary image data to recover the image according to the compression technique.

According to another embodiment of the invention, an image protection method is provided. First, an image is separated into base image data and auxiliary image data according to a compression technique. Then, the base image data is compressed to compressed base image data according to the compression technique, and the auxiliary image data is encrypted to an auxiliary image data cipher. Then, the compressed base image data and the auxiliary image data cipher are composed into a protected image corresponding to the image.

Further, the protected image is decomposed into the compressed base image data and the auxiliary image data cipher. Then, the auxiliary image data cipher is decrypted to the auxiliary image data using a decryption key, and the compressed base image data is decompressed to the base image data. Thereafter, the base image data and the auxiliary image data are combined to recover the image according to the compression technique.

The above-mentioned method may take the form of program code embodied in tangible media. When the program code is loaded into and executed by a machine, the machine becomes an apparatus for practicing the invention.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating a conventional mechanism for digital content protection;

FIG. 2 is a schematic diagram illustrating the architecture of the image protection system according to the present invention;

FIG. 3 is a schematic diagram illustrating the image compression/encryption device of the present invention;

FIG. 4A is a schematic diagram illustrating a region of interest compression technique;

FIG. 4B is a schematic diagram illustrating a resolution compression technique;

FIG. 4C is a schematic diagram illustrating a quality compression technique;

FIG. 5 is a schematic diagram illustrating the image recovery device of the present invention;

FIG. 6 is a flowchart showing the image protection method according to the present invention; and

FIG. 7 is a flowchart showing the image recovery method according to the present invention.

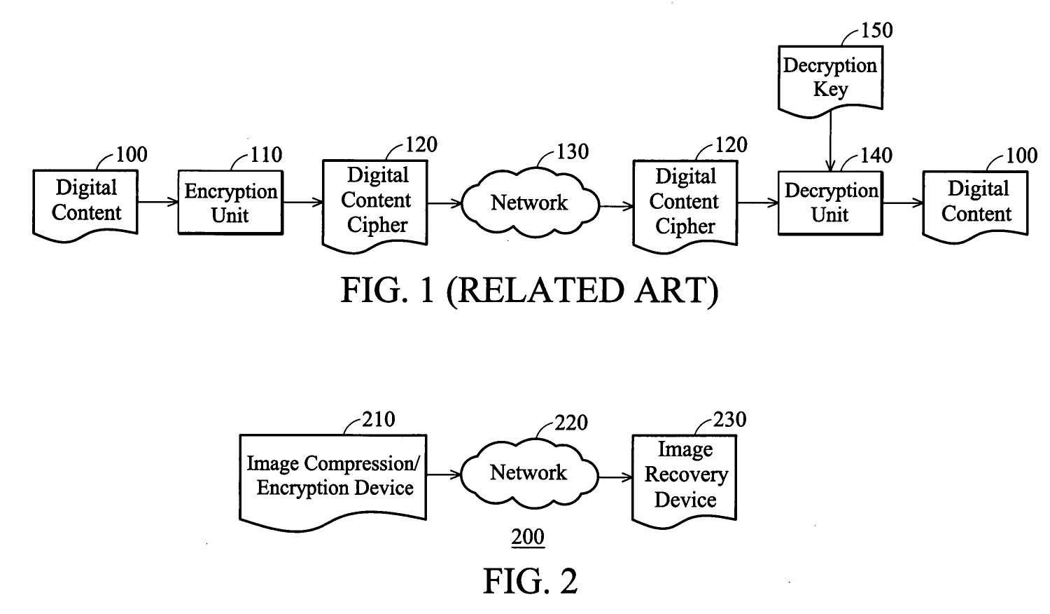

### DETAILED DESCRIPTION OF THE INVENTION

FIG. 2 illustrates the architecture of the image protection system according to the present invention. The image protection system 200 includes an image compression/encryption device 210 and an image recovery device 230. The image compression/encryption device 210 protects images to generate protected images. The protected images can be transmitted to the image recovery device 230 via a network 220. The image recovery device 230 recovers the protected images to the original images. It is understood that network transmission is discussed in the embodiment, however, any kind of image transmission and channels can be used in the present invention.

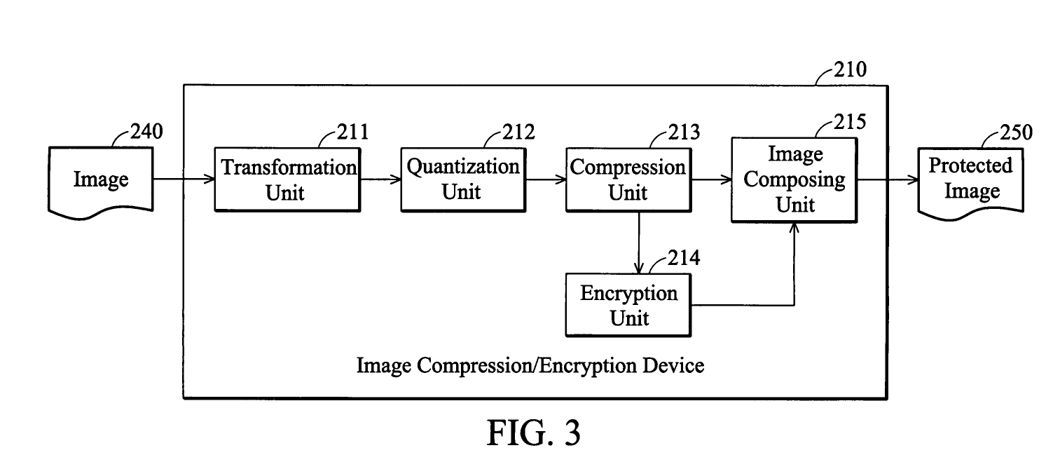

FIG. 3 illustrates the image compression/encryption device 210 of the present invention. It is noted that the embodiment of the present invention is discussed based on JPEG 2000, however, any compression technique is suitable for use in the present invention. The image compression/encryption device 210 includes a transformation unit 211, a quantization unit 212, a compression unit 213, an encryption unit 214 and an image composing unit 215.

The transformation unit 211 performs discrete wavelet transformation (DWT) on an image 240. The quantization unit 212 quantizes each coefficient of the image 240 after the DWT process of the transformation unit 211. The compression unit 213 separates the image 240 into base image data and auxiliary image data according to a compression technique, and compresses the base image data to compressed base image data according to the compression technique. It should be noted that the auxiliary image data can be also compressed by the compression unit 213 to further reduce the size in data transmission. Further, the compression technique may be region of interest (ROI), resolution and quality compression techniques, but is not limited thereto.

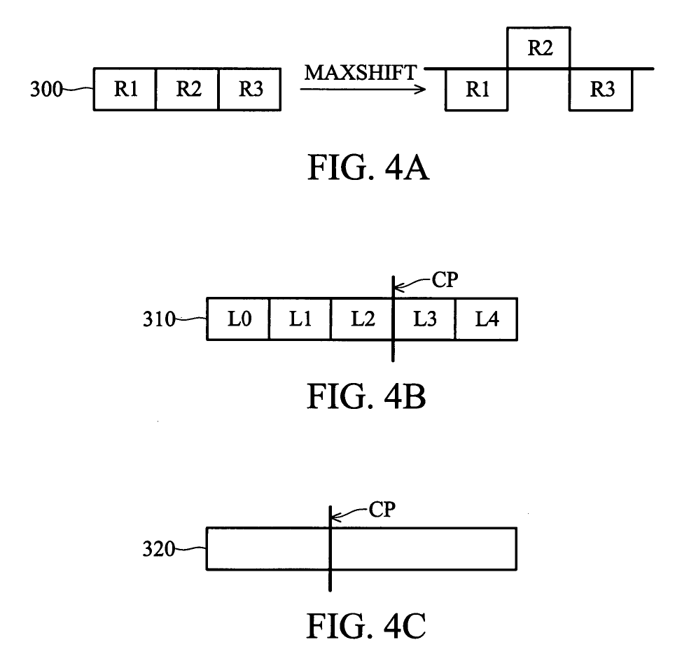

FIGS. 4A, 4B and 4C are schematic diagrams illustrating the ROI, resolution and quality compression techniques respectively. In the FIG. 4A, the image 300 has image data in three regions R1, R2 and R3. If the region R2 is of interest, compression priority of the region R2 can be raised by performing a MAXSHIFT operation, such that the compression priority of the region R2 is greater than that of the regions R1 and R3. At this time, the image data of the region R2 can be the base image data of the image 300, and the image data of the regions R1 and R3 can be the auxiliary image data of the image 300. In practice, protected portion of the image can be set as the auxiliary image data. The image 310 in FIG. 4B arranges image data according to resolution in different levels L0˜L4. At this time, a cut point CP can be placed between any two levels to determine the base image data and the auxiliary image data. In the example, the image data of levels L0˜L2 can be the base image data, and the image data of levels L3 and L4 can be the auxiliary image data. The image 320 in FIG. 4B arranges image data according to quality. Similarly, a cut point CP can be placed arbitrarily to determine the base image data and the auxiliary image data. After ROI compression, users with no authorization can view the image 240 without the protected portion. After resolution compression, users with no authorization can view a thumbnail of the image 240. After quality compression, users with no authorization can view the blurred image 240.

The encryption unit 214 receives the auxiliary image data of the image 240 from the compression unit 213, and encrypts the auxiliary image data to an auxiliary image data cipher. It is understood that the present invention is not limited to any encryption technique. The image composing unit 215 receives compressed base image data and an auxiliary image data cipher from the compression unit 213 and the encryption unit 214 respectively, and composes the compressed base image data and the auxiliary image data cipher into a protected image 250 of the image 240.

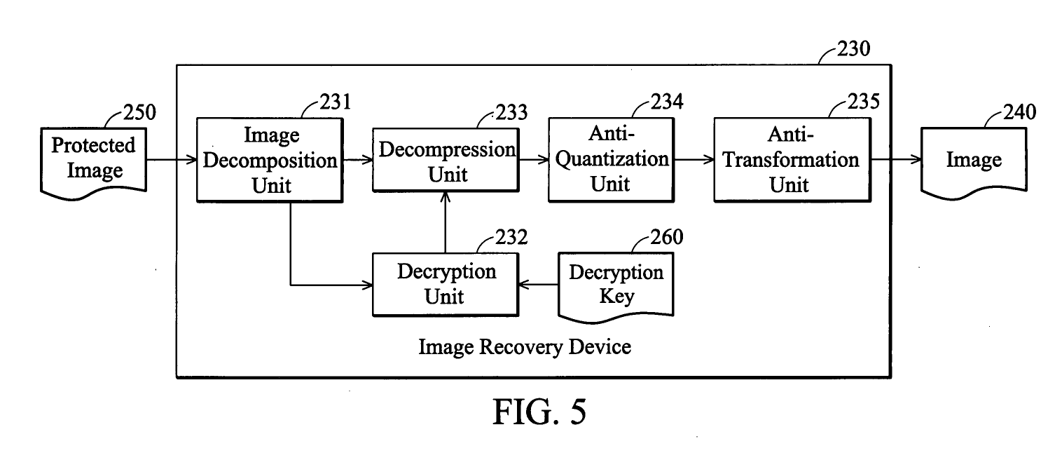

FIG. 5 illustrates the image recovery device 230 of the present invention. The image recovery device 230 has an image decomposition unit 231, a decryption unit 232, a decompression unit 233, an anti-quantization unit 234 and an anti-transformation unit 235. The image decomposition unit 231 decomposes the protected image 250 into compressed base image data and auxiliary image data cipher, and transmits the auxiliary image data cipher and the compressed base image data to the decryption unit 232 and the decompression unit 233 respectively. The decryption unit 232 decrypts the auxiliary image data cipher to auxiliary image data using a decryption key 260, and transmits the auxiliary image data to the decompression unit 233. The decompression unit 233 decompresses the compressed base image data into base image data, and combines the base image data and the auxiliary image data to a combination image according to the compression technique. It is understood that if the auxiliary image data is compressed by the compression unit 213 of the image compression/encryption device 210, the compressed auxiliary image data should be decompressed by the decompression unit 233 in advance before combination with the base image data. Thereafter, the anti-quantization unit 234 and the anti-transformation unit 235 perform anti-quantization and anti-transformation operations on the combination image to recover the original image 240 having the same resolution and quality before compression.

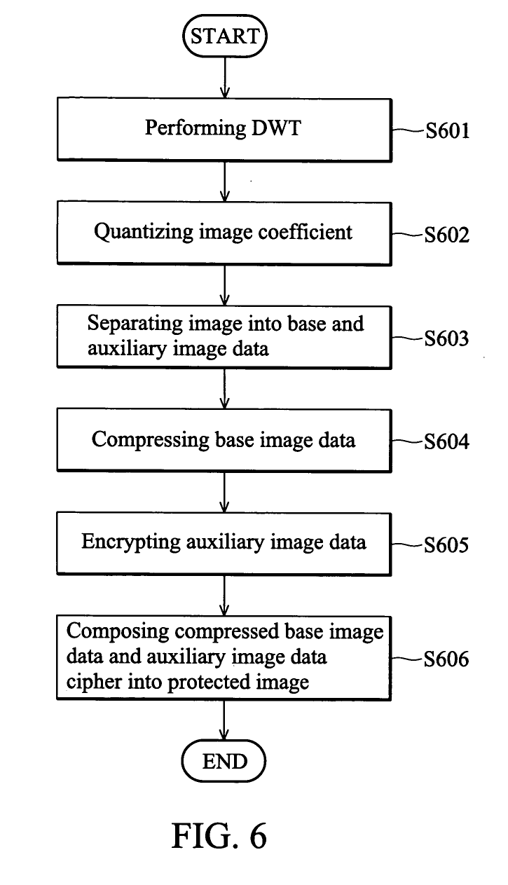

FIG. 6 shows the image protection method according to the present invention. First, in step S601, discrete wavelet transformation is performed on an image, and in step S602, each coefficient of the image is quantized. Then, in step S603, the image is separated into base image data and auxiliary image data according to a compression technique. Then, in step S604, the base image data is compressed to compressed base image data according to the compression technique, and in step S605, the auxiliary image data is encrypted to an auxiliary image data cipher. Thereafter, in step S606, the compressed base image data and the auxiliary image data cipher are composed into a protected image of the image. Similarly, the auxiliary image data can also be compressed to further reduce the size during data transmission.

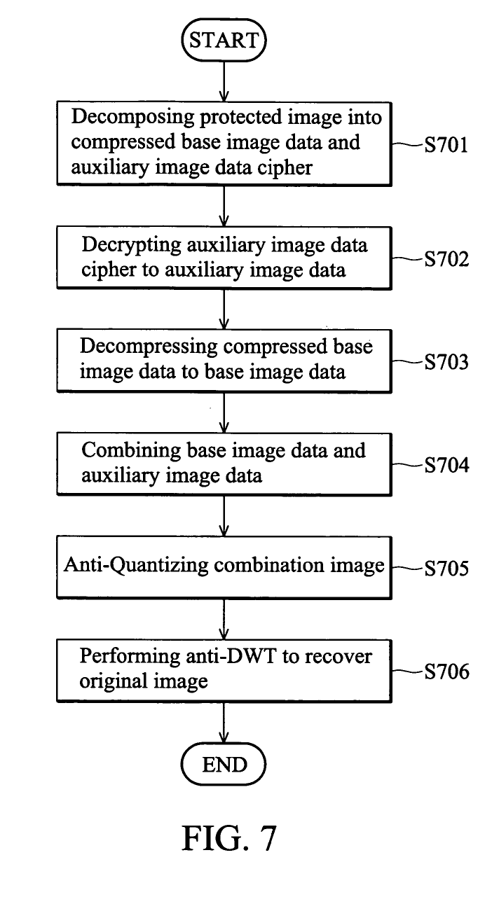

FIG. 7 shows the image recovery method according to the present invention. First, in step S701, the protected image is decomposed into compressed base image data and the auxiliary image data cipher. Then, in step S702, the auxiliary image data cipher is decrypted to auxiliary image data using a decryption key, and in step S703, the compressed base image data is decompressed into base image data according to the compression technique. Thereafter, in step S704, the base image data and the auxiliary image data are combined into a combination image. Similarly, if the auxiliary image data is compressed, the compressed auxiliary image data should be decompressed in advance before combination with the base image data. Then, in steps S705 and S706, anti-quantization and anti-transformation operations are performed on the combination image to recover the original image.

The present invention thus provides an image protection system and method integrating compression and encryption techniques simultaneously, such that users with no authorization can view a partial image, while users with authorization can view a complete image, thereby improving digital content promotion and sales.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. An image protection system, comprising:
an image compression/encryption device, comprising:
a compression unit to separate an image into base image data and auxiliary image data according to a compression technique, and compress the base image data to compressed base image data according to the compression technique;
an encryption unit coupled to the compression unit to receive and encrypt the auxiliary image data to an auxiliary image data cipher; and
an image composing unit coupled to the compression unit and the encryption unit to receive and compose the compressed base image data and the auxiliary image data cipher into a protected image corresponding to the image.

2. The system of claim 1 further comprising:
an image recovery device, comprising:
an image decomposition unit to receive and decompose the protected image into the compressed base image data and the auxiliary image data cipher;
a decryption unit coupled to the image decomposition unit to receive and decrypt the auxiliary image data cipher to the auxiliary image data using a decryption key; and
a decompression unit coupled to the image decomposition unit and the decryption unit to receive the compressed base image data and the auxiliary image data, decompress the compressed base image data to the base image data, and combine the base image data and the auxiliary image data to recover the image according to the compression technique.

3. The system of claim 2 wherein the image compression/encryption device further comprises a transformation unit to perform discrete wavelet transformation on the image in advance.

4. The system of claim 3 wherein the image recovery device further comprises an anti-transformation unit to perform anti-discrete wavelet transformation on the image after the image is combined.

5. The system of claim 4 wherein the image compression/encryption device further comprises a quantization unit to quantize each coefficient of the image after the discrete wavelet transformation.

6. The system of claim 5 wherein the image recovery device further comprises an anti-quantization unit to anti-quantize each coefficient of the image before the anti-discrete wavelet transformation.

7. The system of claim 1 wherein the compression technique is region of interest (ROI) compression.

8. The system of claim 1 wherein the compression technique is resolution compression.

9. The system of claim 1 wherein the compression technique is quality compression.

10. The system of claim 1 wherein the compression unit further compresses the auxiliary image data.

11. An image protection method, comprising the steps of:
separating an image into base image data and auxiliary image data according to a compression technique;
compressing the base image data to compressed base image data according to the compression technique;
encrypting the auxiliary image data to an auxiliary image data cipher; and
composing the compressed base image data and the auxiliary image data cipher into a protected image corresponding to the image.

12. The method of claim 11 further comprising an image recovery method, comprising the steps of:
decomposing the protected image into the compressed base image data and the auxiliary image data cipher;
decrypting the auxiliary image data cipher to the auxiliary image data using a decryption key;
decompressing the compressed base image data to the base image data according to the compression technique; and
combining the base image data and the auxiliary image data to recover the image according to the compression technique.

13. The method of claim 12 further comprising performing discrete wavelet transformation on the image in advance.

14. The method of claim 13 further comprising performing anti-discrete wavelet transformation on the image after the image is combined.

15. The method of claim 14 further comprising quantizing each coefficient of the image after the discrete wavelet transformation.

16. The method of claim 15 further comprising anti-quantizing each coefficient of the image before the anti-discrete wavelet transformation.

17. The method of claim 11 wherein the compression technique is region of interest (ROI) compression.

18. The method of claim 11 wherein the compression technique is resolution compression.

19. The method of claim 11 wherein the compression technique is quality compression.

20. The method of claim 11 further comprising compressing the auxiliary image data.
